(19) United States
(12) Patent Application Publication
(10) Pub. No.: US 2014/0222424 A1
(43) Pub. Date: Aug. 7, 2014

(54) METHOD AND APPARATUS FOR CONTEXTUAL TEXT TO SPEECH CONVERSION

(71) Applicant: STUDYOUTLOUD LLC, Pacific Palisades, CA (US)

(72) Inventors: Valerie Hartford, Pacific Palisades, CA (US); Jerry Philip Robinson, Pacific Palisades, CA (US)

(73) Assignee: STUDYOUTLOUD LLC, Pacific Palisades, CA (US)

(21) Appl. No.: 14/171,693

(22) Filed: Feb. 3, 2014

Related U.S. Application Data
(60) Provisional application No. 61/760,147, filed on Feb. 3, 2013.

(51) Int. Cl. G10L 15/26

(52) U.S. Cl. CPC G10L 15/26
USPC 704/235

(57) ABSTRACT

The present specification discloses systems and methods for contextual text to speech conversion, in part, by interpreting the contextual format of the underlying document, and modifying the literal text so as to reflect that context in the conversion, thereby converting text to contextually appropriate speech.

### BACKGROUND

This application is a U.S. Non-Provisional Patent Application that claims priority pursuant to 35 U.S.C. §119(e) to U.S. Provisional Patent Application 61/760,147, filed Feb. 3, 2013, the contents of which are incorporated by reference in its entirety.

### FIELD OF THE INVENTION

The disclosure generally relates to a detection system for text to speech conversion. More specifically, the disclosure relates to contextual text to speech conversion where levels and sublevels of a written outline are converted to contextually appropriate speech.

### DESCRIPTION OF RELATED ART

Speech synthesis is the artificial production of human speech from a written text. A computer system used for this purpose is called a speech synthesizer or text to speech (TTS) convertor (interchangeably, TTS engine). TTS systems are implemented in software or hardware. Conventional TTS systems convert normal language text into speech while other systems render symbolic linguistic representations, such as phonetic transcriptions into speech.

A speech segment that possesses distinct physical or perceptual properties is called a phone. A diphone is an adjacent pair of phones. A diphone also refers to a recording of a transition between two phones. Phoneme is a set of phones that are cognitively equivalent (i.e., having the same sound).

Synthesized speech can be created by concatenating pieces of recorded speech stored in a database. Systems differ in the size of the stored speech units. A database storing phones or diphones provides the largest output range but lacks clarity to the audience. Specific usage domains store entire words or sentences, providing higher fidelity while consumes large memory space. Alternatively, synthesizers can incorporate a model of the vocal tract and other human voice characteristics to create a completely synthetic voice output.

The quality of a speech synthesizer is judged by its similarity to the human voice and by its ability to be understood. Conventional synthesizers rely on various voice software for TTS conversion.

FIG. 1 schematically illustrates a conventional TTS system architecture. The systems of FIG. 1 include a text analysis module 110, a linguistic analysis module 120 and a sound generation module 130. The text module includes software for converting raw text (including numbers, symbols and abbreviations) into the equivalent of the written-out words. In certain implementations, the software converts the text to phonetic equivalents of the words. The phonetic text is also divided into prosodic units similar to phrases, clauses and sentences. The linguistic module assigns phonetic transcriptions to words. Phonetic transcription and prosody information is combined in the sound generation module to produce audible sound. Additional software functionality may be included to define pitch, tone, phonem emphasis and duration imposed on the audible signal.

While conventional TTS systems can convert most written text to speech, such systems are not able to decipher text formats unique to certain textual representations. For example, conventional TTS engines are not able to convert a multi-branched outline into a meaningful auditory file. Therefore, there is a need for a TTS method and system capable of contextual conversion of text to speech.

### SUMMARY

An embodiment of the disclosure is directed to a text to speech conversion engine capable of contextually converting written text into audible speech. Contextual conversion involves modifying the literal written text based on semantic context before converting it to and delivering it in auditory format.

In one embodiment, the disclosure relates to a contextual TTS engine for applying contextual conversion to an outline and providing an audio presentation of the converted result. An exemplary implementation includes creating an audio file for one line of the outline, reading the line to the audience, deleting that audio file for the displayed line and repeating the process for the next line. While reference is made herein for creating an audio file for one line of the outline at a time, it is noted that an audio file can be created for multiple lines of the outline at each time without departing from the principles of the disclosure.

In another embodiment, the disclosure relates to a system for providing contextually converted text to speech files, the system comprising: a processor circuit in communication with a memory circuit; the memory circuit programmed with instructions directing the processor to: receive a text file, the text file containing an outline presentation with one or multiple rows, identify contextually relevant formatting of the outline as a whole, identify the text portion of a selected row of the outline, identify contextually relevant formatting and words for the selected row, convert the text portion of the selected row into speech and impose a presentation format consistent with the contextual portion for the selected row and the outline as a whole, create a speech file containing the contextually converted text portion of the selected row plus any added contextual cues; speak the selected row and repeated the process for the next selected row.

The memory circuit can comprise non-transient storage. The memory circuit and the processor circuit define a text-to-speech engine. The speech file may be configured for play back at a receiver device. The receiver device can be any computing device now know or later developed, including but not limited to desktop computers, mobile phones, smartphones, laptop computers, tablet computers, personal data assistants, gaming devices, etc. The step of converting the text portion of the document may include identifying a presentation context for the received file and imposing a format consistent with the presentation on the text portion.

In another embodiment, the disclosure relates to a method for providing an audio presentation for an outline, the method comprising: receiving a text file, the text file containing an outline presentation; identifying the text portion of the received filed; identifying the contextual format of the received file; converting a selected portion (e.g., a row of the outline) of the text portion of the file to speech and imposing a presentation format consistent with the contextual portion of the received filed; and creating a speech file of the text portion of the row having a contextual format. The text file can have a format compatible with open-source, freeware, shareware, or commercially available word processing, spreadsheet application software, presentation program software, desktop publishing, concept mapping/vector graphics/image software as well as character coding schemes. The speech file can be edited using natural speech such as speaker's voice.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates a conventional TTS system architecture;

FIG. 2 is a flow-diagram illustrating an algorithm according to at least one embodiment of the invention;

FIG. 3 illustrates an exemplary outline stratification, in accordance with at least one embodiment;

FIG. 4 is a schematic diagram of an exemplary apparatus for implementing an embodiment of the disclosure;

FIGS. 5A and 5B are illustrations of exemplary graphical user interfaces, as displayed on an exemplary computing device, in accordance with at least one embodiment;

FIGS. 6A and 6B are illustrations of further exemplary graphical user interfaces, as displayed on an exemplary computing device, showing exemplary Outline Detail and Play View interfaces, in accordance with at least one embodiment;

FIGS. 7A and 7B are illustrations of further exemplary graphical user interfaces, as displayed on an exemplary computing device, showing an exemplary playback set up interface, in accordance with at least one embodiment;

FIGS. 8A and 8B are illustrations of further exemplary graphical user interfaces, as displayed on an exemplary computing device, showing an exemplary activation interface of an inactive row, in accordance with at least one embodiment;

FIG. 9 is an illustration of a further exemplary graphical user interface, as displayed on an exemplary computing device, showing an exemplary interface menu appearing under the Actions Icon, in accordance with at least one embodiment;

FIGS. 10A and 10B are illustrations of further exemplary graphical user interfaces, as displayed on an exemplary computing device, showing exemplary playback features, in accordance with at least one embodiment; and

FIGS. 11A-11F are illustrations of further exemplary graphical user interfaces, as displayed on an exemplary computing device, in accordance with at least one embodiment.

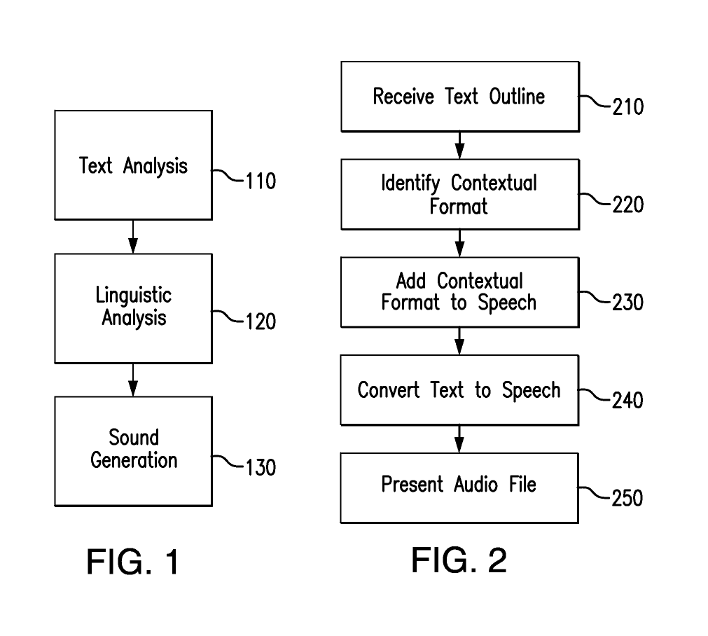

### DETAILED DESCRIPTION

The disclosure generally relates to methods and systems for contextual text to speech conversions. The disclosed embodiments extend TTS capability to include interpreting the contextual format of the underlying document, and modifying the literal text so as to reflect that context in the conversion. An exemplary embodiment provides for converting an outline (e.g., academic outline) from a text format to a coherent audible speech. The converted speech retains the contextual (interchangeably, semantic) format of the underlying document, thereby delivering the context of the document as well as its text.

In an exemplary embodiment, a text outline is created using conventional word processing or outline software. The text file may be converted into an outline format or uploaded without directly into a server or a file hosting application. Using a computing device the user, or a party authorized by the user, may upload the outline onto the computing device. The user may then select a starting point for conversion by, for example, selecting a row in the outline. Once a starting row is selected, the TTS contextually converts that row, renders it as audio, and plays the conversion. Upon playing the first row based on the selected starting location, the TTS moves to the next row. In converting the text into speech, the TTS first identifies the contextual format of the whole outline, then identifies context formatting within the row-to-play, then modifies the row text based on the context formatting, then converts the selected row to an audio speech file and plays the file for the user.

FIG. 2 is a flow-diagram illustrating an algorithm according to one embodiment of the disclosure. The exemplary steps of FIG. 2 can be implemented at a TTS engine, on computer, a server, a portable device or on a cloud-based system. At step 210, an outline is received at the TTS engine. The outline (interchangeably, text outline) may be in any conventional format including open-source, freeware, shareware, or commercially available word processing, spreadsheet application software, presentation program software, desktop publishing, concept mapping/vector graphics/image software as well as character coding schemes. For example, the text may be a document produced using word processing software, such as, e.g., AbiWord, Bean, Callifra Words, GNU TeXmacs, KWord, LibreOffice Writer, LyX, NeoOffice, Ted, Symphony, GOOGLE® Docs, Jarte, INCOPY®, HANGUL®, ICHITARO®, MELLEL®, NISUS WRITER®, PAGES®, KINGSOFT WRITER®, STAROFFICE WRITER®, TEXTMAKER®, WORD®, WORDPAD®, WORDPERFECT®, WORDPRO®, spreadsheet application software, such as, e.g., Calligra Sheets, Gnumeric, KCells, OpenOffice.org Calc, LibreOffice Calc, NeoOffice, Siag, Symphony, PlanMaker, NUMBERS®, QUATTRO PRO®, EXCEL®, LOTUS 1-2-3®, PLANMAKER®, QUANTRIX®, OPEN OFFICE CALC®, and WORKS®, presentation program software such as, e.g., Beamer, Calligra Stage, Ease, MagicPoint, OpenOffice.org Impress, LibreOffice Impress, NeoOffice, Powerdot, Simple Slides, Tech Talk PSE, Symphony Presentations, FreeOffice Presentations, Brainshark, Docstoc, Prezi, Scribd, SlideRocket, wePapers, ACROBAT®, KEYNOTE®, COREL PRESENTATIONS®, GOOGLE® DOCS, HARVARD GRAPHICS®, FREELANCE GRAPHICS®, POWERPOINT®, and SOFTMAKER PRESENTATIONS®, desktop publishing, such as, e.g., Scribus, LyX, PagePlus, Fatpaint, ACROBAT®, FRAMEMAKER®, INDESIGN®, PAGEMAKER®, VENTURA®, PUBLISHER®, PAGEPLUS®, PAGES®, PAGESTREAM®, QUARKEPRESS®, RAGTIME®, and/or concept mapping/vector graphics/image software, such as, e.g., Dia, LinreOffice Draw, Compendium, Docear, FreeMind, Freeplane, XMind, Embroidermodder, Inkscape, Ipe, Karbon 14, sK1, Skencil, 3D TOPICSCAPE®, IDEA PROCESSOR®, IMINDMAP®, COGGLE®, CREATELY®, DEBATEGRAPH®, INSPIRATION®, MINDGENIUS®, MINDJET®, MINDMAPLE®, MINDMAPPER®, MIND MEISTER®, MINDOMO®, MINDVIEW®, NOVAMIND®, OMNIGRAFFLE®, PERSONALBRAIN®, PREZI®, QIQQA®, SEMANTICA®, SMARTDRW®, SPICYNODES®, TINDERBOX®, VISUAL MIND®, XMIND PRO®, YED®, CORELDRAW®, ILLUSTRATOR®, PHOTOSHOP®, DRAWPLUS®, PHOTOLINE®, COREL PHOTOPAINT®, VISIO®, as well as character coding schemes such as, e.g., ASCII, UTF-8, UTF-16, and UTF-32. The text outline may be received directly from a memory device or it can be retrieved from a cloud-based storage system.

The process of FIG. 2 may be repeated after each row is converted to an audio file and played to the user. In one embodiment of the disclosure, the TTS application breaks down the outline to multiple levels, with each level representing one or more rows of the outline. The user may also advance (fast forward) or rewind the playback by selecting a different portion of the outline or by tapping the appropriate (fast-forward, rewind or replay) buttons on the computing device. The user maintains complete control during playback and may decide to play the entire outline or portions of the outline. In addition, the user may skip through the outline, play pre-selected portions or replay desired portions of the outline. If the user does not move the cursor forward or backward, the TTS automatically progresses to the next row in the outline.

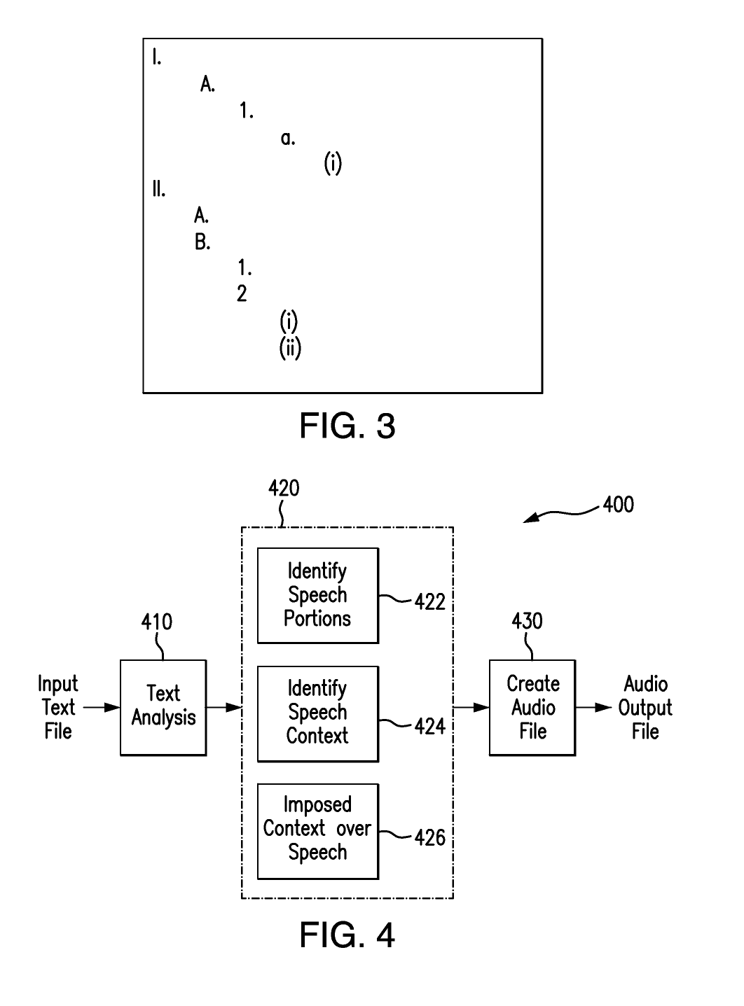

The text outline may reflect a hierarchy with multiple levels of detail. For example, the outline may include conventional classifications. FIG. 3 illustrates an exemplary outline classification which can be converted. As illustrated in FIG. 3, the outline can contain several levels. The first row is at level 1, identified by Roman numerals (I, II, III, IV, etc.). The second row is at level 2, identified by capital letters (A, B, C . . .). The third row is at level 3, identified by numbers (1, 2, 3 . . . ). The fourth row is at level 4, identified by lower letters (a, b, c . . . ) and the fifth row is at level 5, identified by lower level Roman numerals (i, ii, iii, iv . . . ). Alternative hierarchies can be used without departing from the disclosed principles.

While conventional TTS engines convert each written row character (e.g., “ii” or “A”) into speech, the disclosed embodiments provide contextual conversion of the row characters. For example, the ‘I.’ at the beginning of row 1 would be read by a conventional text to speech converter as ‘Aye’. However, with appropriate contextual conversion, it is read by the invention as “Roman Numeral One.” Consequently, a proper outline format is delivered to the recipient.

Referring again to FIG. 2, at step 220 the contextual format of the outlined is determined. This step can be done at a processor circuit in communication with a memory circuit. At step 230, the contextual format (step 220) is overlaid or combined with the textual data. At step 240, the text of the outline is converted into speech. At step 250, the compilation audio file is prepared for delivery or storage. In the exemplary embodiment of FIG. 2, the semantic translation is done in the text form of the line and prior to converting the text portion of the row into speech. In other words, the contextual translation of the outline is done while the row is in the text format. However, dissimilar conversion sequences may be implemented without departing from the principles of the disclosure.

FIG. 4 is a schematic diagram of an exemplary apparatus for implementing an embodiment of the disclosure. As shown in FIG. 4, text is received at text analysis module 410. Text analysis module can comprise an independent software in communication with a processor and memory circuit, or it can be part of the larger system of FIG. 4. In an embodiment of the disclosure, text analysis module converts incoming data file to the format required for processing by conversion module 420. The incoming file may be, for example, an OPML file.

Conversion module 420 is illustrated having exemplary sub-modules 422, 424 and 426. At sub-module 422 the speech potion of the text file (not shown) is identified. As a corollary sub-module 422 may also identify non-text portions of the speech file to sub-module 424.

In one embodiment, sub-module 424 parses outline text to determine if outline rows have identifiers (e.g., I., A., 1 . . . ). The initial definition of a row identifier can be any string of characters beginning at the start of the line where the strings end, for example, in “.”, “)” or and the preceding characters are letters and/or numbers. Identifying context enables the TTS engine to provide a context to the underlying text. In addition, row identifier may be analyzed to determine if any outline levels use Roman numbering. If so, the system will, by default, speak the words “Roman Numeral” before speaking the number value of the row's identifier. The app may then prepend the speaking of all other rows with “Point”. The system may also modify intonation so that row prefixes such as “Point A” drop in pitch, signifying their separateness from the outline content. Finally, the system may add aesthetically pleasing delays between rows and sections to further increase intelligibility.

Sub-module 426 imposes contextual format over the speech portion of the text. Here, the system can make multiple files or a single file containing speech and its corollary context. Module 430 receives information from module 420 and provides an output file.

As stated, system 400 of FIG. 4 can be implemented at software or an applet (“app”) configured for implementation on computing devices. To this end, the software (or applet) can receive text files and perform the necessary steps to provide output file as shown in FIG. 4. The file may be one row of the outline, upon playback of which the TTS engine automatically goes to the next row. The software can communicate with a processor circuit and a memory circuit to implement the desired TTS conversion. System 400 may comprise additional functionality to save files and/or broadcast (wirelessly) the output files. The output file is an audio output. Once played, the TTS engine starts processing the next row of the outline.

By way of example, a subscriber can create an academic outline in a conventional format (e.g., OPML) using a computing device such as a desktop computer. The outline can be uploaded to another computing device, such as a mobile device, using conventional means. That text is analyzed and then semantically translated one line at a time, each such line being converted a line at a time into audio files which are played on the device. The subscriber can then retrieve the audio file from any device capable of downloading the text file.

All manipulation in the GUI is done relative to textual representations of outline rows. For example, the user can touch a row to serve as the starting point for speaking the outline. Under this implementation, the subscriber can identify location of interest in the text file as displayed on the computing device and skip directly to the desired location. Another feature is the ability to skip over sections of the file through fast-forward or rewind functions. Skipping applies in two contexts. First, the user can skip over rows using fast forward/rewind or by touching a row to move the start-speaking point. In this context, the skipped rows are still active, they have just been bypassed as a result of user interaction. Second, by swiping on a row, or selecting the Skip All option on the Actions menu, the user can set rows or entire sections of the outline to not be spoken (to be skipped) when speaking the outline.

Support for external controls, such as the button on ear buds, can be used to start and stop the playing of the speech rendition. Other input/output features common to music replay may also be used without departure from the disclosed principles.

As stated, the disclosed embodiments may be implemented, in at least one embodiment, as an app on a portable device such as a smart phone. The following examples show functional features of the disclosed embodiment on an exemplary computing device.

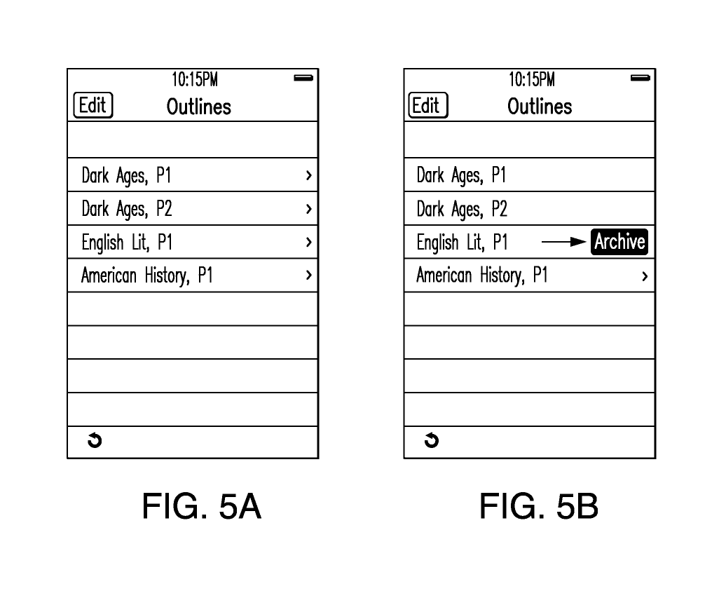

FIGS. 5A and 5B are the list view displays of an outline interface on an exemplary device. The shown outlines were synchronized with a user's DROPBOX® folder on his/her computer. The navigation bar shows titles of various outlines. The “Edit” buttons on top left corner of the display allows editing the displayed outlines. FIGS. 5A and 5B also show a search field with clear button below the navigation bar. Finally, there is an undo icon in the Tab Bar at the bottom of the screens.

Entering a value into the search field filters the list to include only outlines whose names or text contain the entered value. A single-tapping the NextView arrow on any row directs reader to Screen 2, shown in FIG. 5B. Clicking the Edit Button reveals DeleteCircles left of the outline icons. Clicking a DeleteCircle brings up an ActionSheet with Archive and Cancel options. If the user archives, the Undo Icon in the Tab Bar becomes active, and, if tapped, unarchives the outline. Swiping on any row brings up an Archive button at the right end of the row. Clicking the Archive button brings up an ActionSheet with Archive and Cancel options. If the user archives, the Undo Icon in the Tab Bar becomes active, and, if tapped, undeletes the outline. In one embodiment, archives go into effect when the user leaves the app by any path.

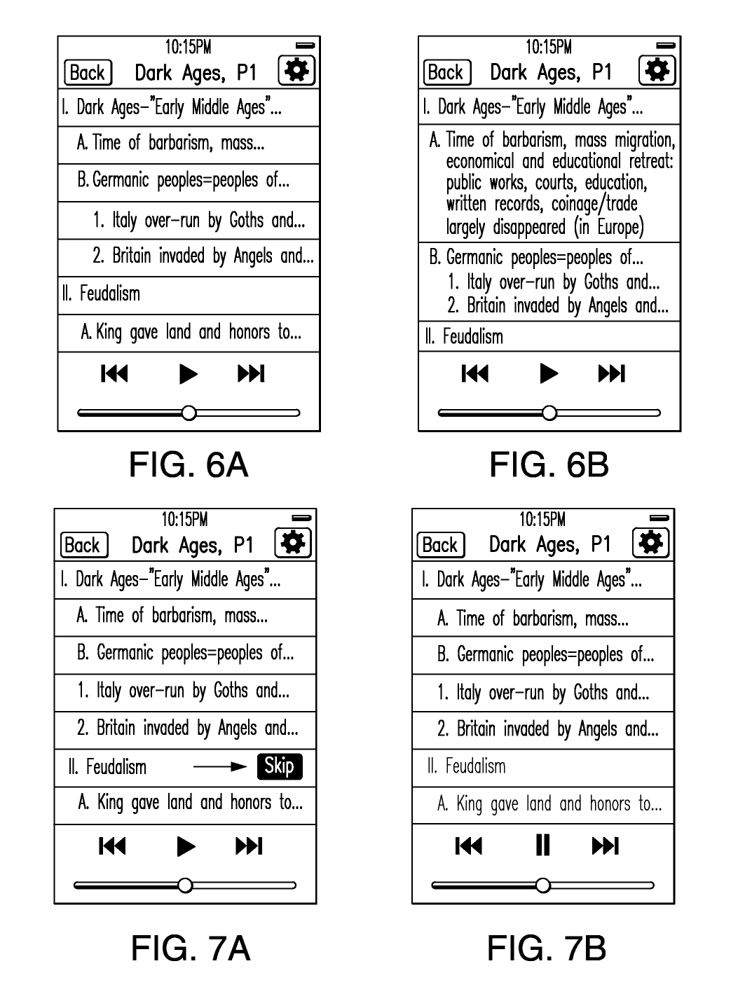

FIGS. 6A and 6B are the Outline Detail and Play View according to an exemplary embodiment of the disclosure. Specifically, FIGS. 6A and 6B show an outline view showing text of outline with section numbers/letters. FIGS. 6A and 6B show a Navigation Bar at the top of the screen with a Back button and an Actions Icon as well as a Media Controller at the bottom of the screen (Rewind, FastForward, and Play) along with a Volume Slider. A small speaker icon is displayed. It appears grey in color unless the outline is being spoken, in which case it turns green. Double tapping on any row expands the row to show the text of the row. Clicking the Back button takes the user back to the previous screen (FIG. 6A), while single-tapping on any row moves the Play-Start icon to that row.

FIGS. 7A and 7B show exemplary playback set up. Swiping a new row reveals a Skip button (FIG. 7A) at the right end of the row. Clicking the Skip button causes the row—and all its children—to become inactive (FIG. 7B). The inactive rows are appear in grey color and will not play when playback is started. In one embodiment, the Play-Start icon does not change location when rows are set to be skipped.

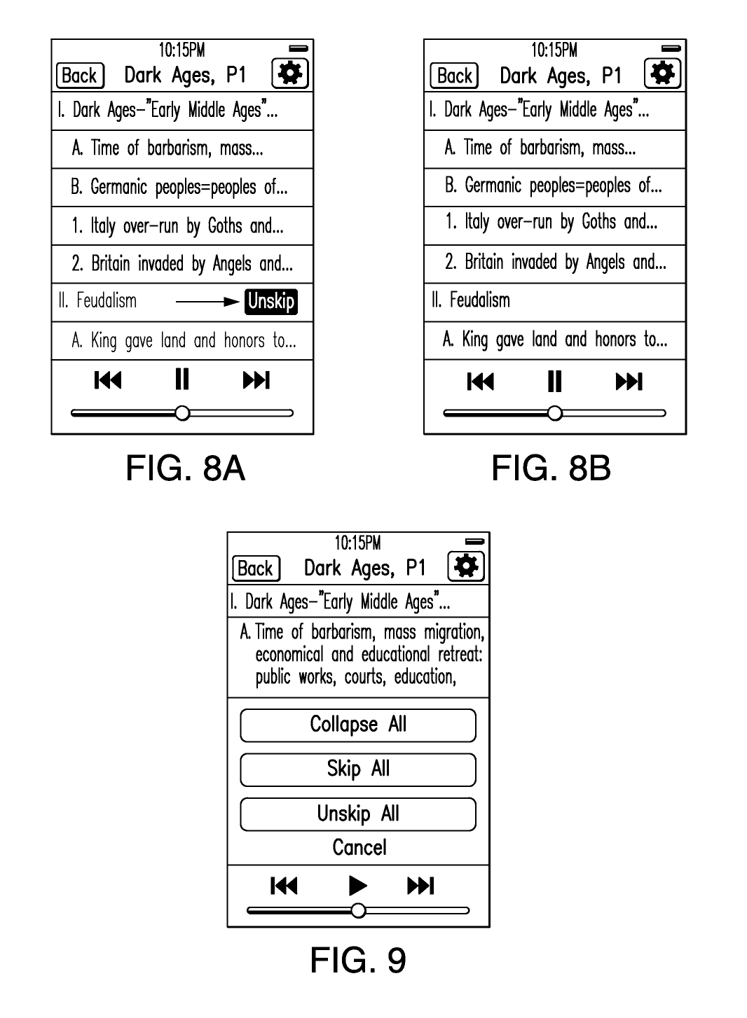

FIGS. 8A and 8B show that swiping an inactive row reveals a green UnSkip button at the right end of the row. Clicking the UnSkip button causes the row—and all its children—to become active. These rows appear in standard (active) text color and will play when playback is started. In the exemplary embodiment, the Play-Start icon does not change location when skipped rows are unskipped so as not to disorient the user.

FIG. 9 shows that clicking the Actions Icon brings up an Action Sheet with four buttons: Either All Rows or Top Level Rows Only, Skip All, UnSkip All, and Cancel. (All Rows appears if some outline levels were previously hidden by clicking Top Level Rows Only. Top Level Rows Only appears if all outline levels were previously displayed by clicking All Rows.) Clicking All Rows shows all outline levels. Clicking Top Level Rows Only hides all but the top level rows. Clicking Skip All sets all top-level outline rows (and as a result, their children) to be skipped on playback. This facilitates quickly setting only a subset of major sections to play. Clicking UnSkip All sets all top-level outline rows (and as a result, their children) to be played on playback. Clicking Cancel hides the Action Sheet without taking any actions.

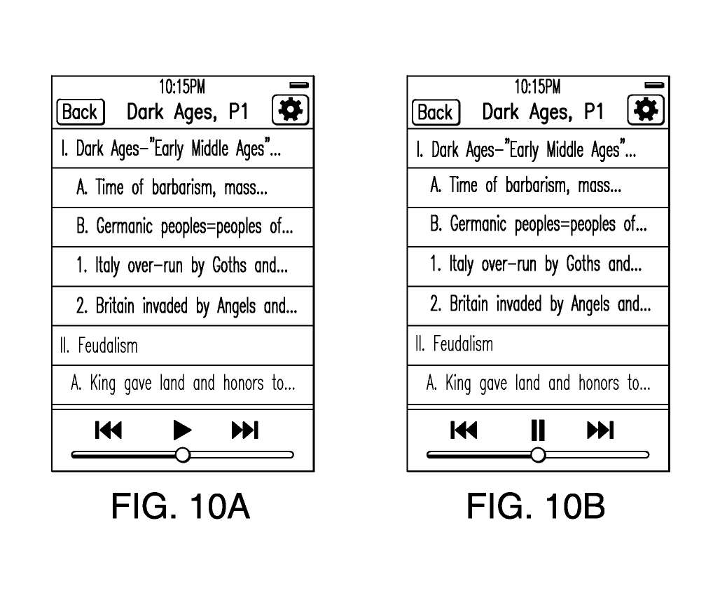

FIG. 10 shows playback features of an exemplay embodiment. Here, single-tapping the Play button at the bottom of the screen begins playback of the outline. Playback begins with the row marked with the Play-Start icon, unless that row is skipped, in which case playback begins with the first unskipped row after the row with the Play-Start icon. When playback starts, the Play button is replaced by a Pause button, and the Play-Start icon turns from grey to green. The Play-Start icon moves down as playback progresses, so it always appears on the row that is playing back. When the last unskipped row has played, playback stops and the Play-Start icon turns from green to grey. Single-Tapping the Pause button pauses playback. When playback is paused, the Pause button is replaced by a Play button, and the Play-Start icon turns from green to grey. Single-Tapping the Rewind button replays the last-played row. Single-tapping the Fast Forward button advances the Play-Start icon to the next row and plays that row.

Single-Tapping the Rewind and Fast Forward buttons, or single-tapping a row to move the Play-Start icon, work whether the outline is playing back or not. If it is playing, playback continues with the appropriate row. If not, the app moves the Play-Start icon to the appropriate row. Moving the Volume slider allows the user to change the volume for OutlinesOutloud without affecting the volume for other apps.

Additional settings can be implemented. For example, clicking a “gears” symbol can bring up Settings pane. This pane will give the user the ability to, among others, (1) set text color for Level 0 rows (the “top” level of the outline structure), and separately as a group, for all non-Level 0 rows; and (2) vary the speed of speech during outline playback, (3) toggle the use of derived row prefixes (such as “Roman Numeral xxx”), and select synchronization methods.

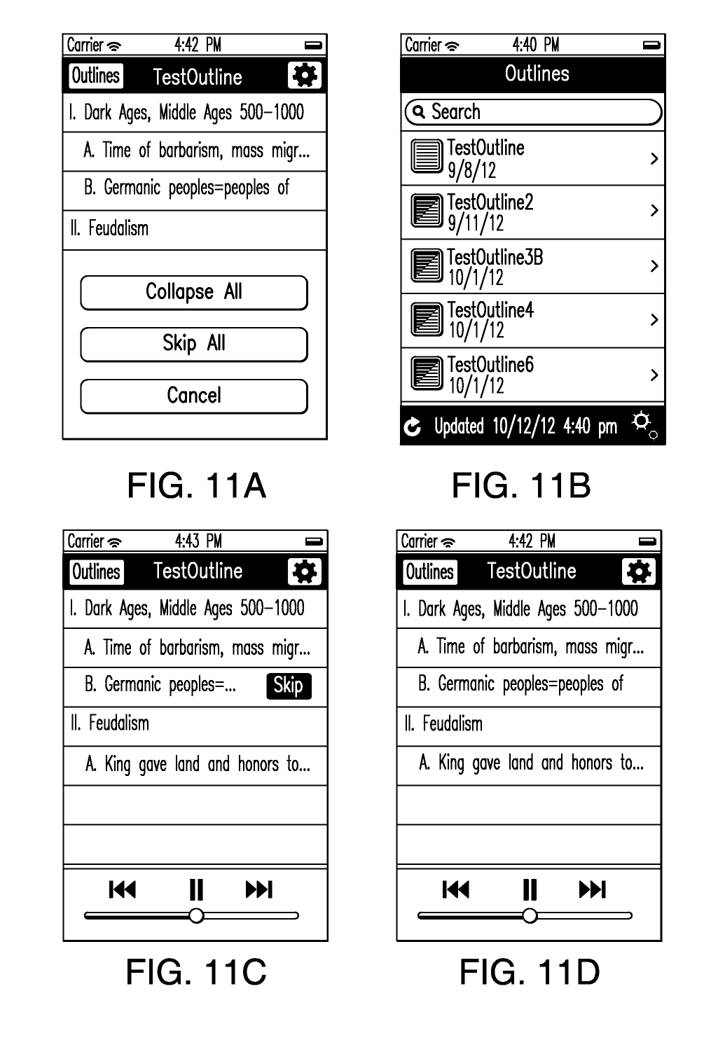

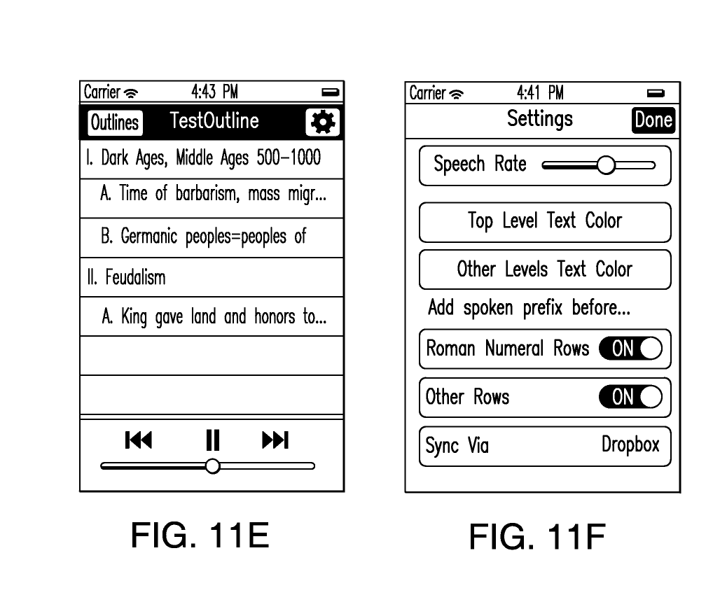

FIGS. 11A-11F show exemplary graphic user interfaces according to various embodiments of the disclosure.

Regarding the exemplary embodiments of the present invention as shown and described herein, it will be appreciated that a system and associated methods for contextual text to speech conversion are disclosed. Because the principles of the invention may be practiced in a number of configurations beyond those shown and described, it is to be understood that the invention is not in any way limited by the exemplary embodiments, but is generally directed to a system and associated methods for contextual text to speech conversion and is able to take numerous forms to do so without departing from the spirit and scope of the invention. It will also be appreciated by those skilled in the art that the various features of each of the above-described embodiments may be combined in any logical manner and are intended to be included within the scope of the present invention.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A system for providing contextual text to speech files, the system comprising:
a processor circuit in communication with a memory circuit;
the memory circuit programmed with instructions directing the processor to:
receive a text file, the text file containing an outline presentation,
identify the contextual format of the received file,
identify the text portion of the received filed,
convert a selected row of the text file to speech while imposing a presentation format
consistent with the contextual portion of the received filed, and
create a speech file containing the text portion having a contextual format.

2. The system of claim 1, wherein the memory circuit defines a non-transient storage.

3. The system of claim 1, wherein the memory circuit defines a transient storage.

4. The system of claim 1, wherein the memory circuit and the processor circuit define a text-to-speech engine.

5. The system of claim 1, wherein the speech file is configured for play back at a receiver device.

6. The system of claim 1, wherein the step of converting the text portion further comprises identifying a presentation context for the received file and imposing a format consistent with the presentation on the text portion.

7. A method for providing an audio presentation for an outline, the method comprising:
receiving a text file, the text file containing an outline presentation;
identifying the contextual format of the received file;
identifying the text portion of the received filed;
converting a selected row in the text portion to speech and imposing a presentation format consistent with the contextual portion of the received filed; and
creating a speech file containing the text portion having a contextual format.

8. The method of claim 7, wherein the text file is received with a format identified as an outline format.

9. The method of claim 7, wherein the text file has a format compatible with one or more open-source, freeware, shareware, or commercially available word processing, spreadsheet application software, presentation program software, desktop publishing, concept mapping/vector graphics/image software and/or a character coding scheme.

10. The method of claim 7, further comprising storing the speech file at a memory.

11. The method of claim 7, further comprising editing the speech file using natural voice.
